(19) United States
(12) Patent Application Publication
(10) Pub. No.: US 2017/0055028 A1
(43) Pub. Date: Feb. 23, 2017

(54) DEVICE FOR PLAYING AUDIO AND VIDEO

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventor: Wei LIU, Beijing (CN)

(21) Appl. No.: 15/239,187

(22) Filed: Aug. 17, 2016

Related U.S. Application Data
(63) Continuation of application No. PCT/CN2016/082041, filed on May 13, 2016.

(30) Foreign Application Priority Data
Aug. 21, 2015 (CN) 201510522716.2

(51) Int. Cl. H04N 21/4363; H04N 21/41; H04N 21/4402; H04N 7/01

(52) U.S. Cl. CPC H04N 21/43635; H04N 7/0127; H04N 7/0117; H04N 21/4122; H04N 21/43637; H04N 21/440263

(57) ABSTRACT

The embodiments of the present application provide a device for playing audio and video, including a first video format conversion bridge chip, a processor and a second video format conversion bridge chip, wherein the first video format conversion bridge chip is configured to receive audio and video signals and convert the data format of the video signals in the audio and video signals; the processor then converts the converted video signals in the audio and video signals into first data format video signals; and the second video format conversion bridge chip receives and converts the first data format video signals into second data format video signals, and provides the signals to a display screen to play, thus enabling the device for playing audio and video to both have high-definition picture and the function of being suitable for executing large-scale software, so as to improve the user experience and willingness to use.

### CROSS REFERENCE TO RELATED APPLICATIONS

This application is a continuation application of International Application No. PCT/CN2016/082041, filed on May 13, 2016, which claims priority to Chinese Patent Application No. 201510522716.2, filed on Aug. 21, 2015, the entire contents of which are incorporated herein by reference.

### TECHNICAL FIELD

The present application relates to a field of multimedia technologies, and, more particularly, to a device for playing audio and video.

### BACKGROUND

For a solution employed to execute audio and video playing functions, current audio and video players (such as a smart TV) can only meet the use demand of playing a video or playing a small game since the processing capacity of a processor thereof is lower. However, for the use demand of executing large-scale games, its processing capacity for large games is far insufficient. Therefore, if gainers want to execute operations of large-scale games through a general audio and video player, it is required to purchase an additional game machine to execute, such as Microsoft XBOX ONE or Sony PS4 for playing the large-scale games on a smart TV.

Therefore, the current audio and video player cannot comply with the use demand for one machine multi-purpose, and additional equipment is needed, which merely increases the cost, thus resulting in poor user experience so as to reduce their willingness to use the device for playing audio and video.

### SUMMARY

The present application provides a device for playing audio and video which can solve the problems in the related art that the use demand for a machine serving several purposes cannot be satisfied, which results in poor user experience and reduces the willingness of users to use the device for playing audio and video.

The present application provides a device for playing audio and video, including: a first video format conversion bridge chip, a processor and a second video format conversion bridge chip. Wherein, the first video format conversion bridge chip is configured to receive audio and video signals, and convert the data format of the video signals in the audio and video signals; the processor is coupled to the first video format conversion bridge chip and the second video format conversion bridge chip respectively, and the processor is configured to receive the converted video signals outputted by the first video format conversion bridge chip, convert the converted video signals into first data format video signals, and transmit to the second video format conversion bridge chip; and the second video format conversion bridge chip is coupled to the processor and a display screen for receiving the first data format video signals and converting the first data format video signals into second data format video signals, and transmitting the second data format video signals to the display screen.

According to the device for playing audio and video provided by the present application, such as a smart TV, audio and video signals in different data formats may be received by the device for playing audio and video and played on the display screen through the configuration of the high-performance processor having performance indexes apparently higher than that of a general processor, and converting the data format of the video signals by the first video format conversion bridge chip and the second video format conversion bridge chip, so that the device for playing audio and video not only can provide a high-quality video viewing function, but also has the efficacy of executing high power consumption software. Therefore, for the aspect of use, the device for playing audio and video enables users to view high-quality videos, and can also comply with the use demand for executing large-scale games at the same time, so that the entire audio-visual entertainment efficacy of the device for playing audio and video is enhanced, the user experience is substantially improved, and the cost for additionally purchasing a game machine is saved.

### BRIEF DESCRIPTION OF THE DRAWINGS

In order to explain the technical solutions in the embodiments of the application or in the prior art more clearly, the drawings used in the descriptions of the embodiments or the related art will be simply introduced hereinafter. It is apparent that the drawings described hereinafter are merely some embodiments of the application, and those skilled in the art may also obtain other drawings according to these drawings without going through creative work.

FIG. 1 is a block diagram of a first embodiment of a device for playing audio and video according to the present application;

FIG. 2 is a block diagram of a second embodiment of a device for playing audio and video according to the present application; and

FIG. 3 is a block diagram of a third embodiment of a device for playing audio and video according to the present application.

### DETAILED DESCRIPTION

To make the objects, technical solutions and advantages of the embodiments of the present application more clearly, the technical solutions of the embodiments of the present application will be clearly and completely described hereinafter with reference to the embodiments and drawings of the present application. Apparently, the embodiments described are merely partial embodiments of the present application, rather than all embodiments. Other embodiments derived by those having ordinary skills in the art on the basis of the embodiments of the application without going through creative efforts shall all fall within the protection scope of the present application.

The device for playing audio and video and/or audio and video output equipment disclosed by the embodiments of the present application is configured to transmit the video signals to the display screen, wherein the device for playing audio and video may be, but is not limited to a TV set, such as a smart TV, while the audio and video output equipment may be such a video and audio apparatus like a DVD player or a set top box or the like externally connected to the device for playing audio and video. The above is exemplary and explanatory only, and is not intended for limitation.

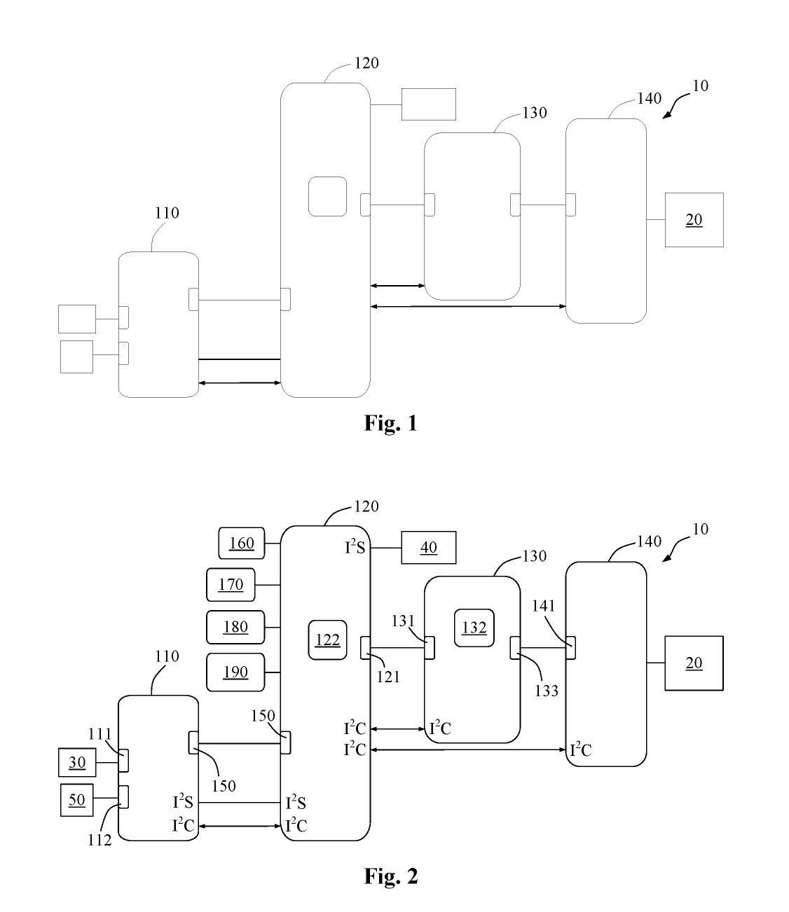

Referring to FIG. 1, a device for playing audio and video 10 disclosed by a first embodiment of the present application includes a first video format conversion bridge chip 110, a processor 120 and a second video format conversion bridge chip 130. The first video format conversion bridge chip 110 is configured to receive audio and video signals and convert the data format of the video signals in the audio and video signals, wherein the audio and video signals may be main audio and video signals from a TV signal source, a signal source from internet or a signal source downloaded locally; or the external audio and video signals from such external signal source as a DVD player or a set top box or the like. The processor 120 is a processor having a master frequency and a register bit higher than that of a general processor. For example, if the general processor has 32 bits and a master frequency of 1.2 GHz, then the processor 120 may be a 64-bit processor having a master frequency of 2˜2.5 GHz, but is not limited to this. The processor is coupled to the first video format conversion bridge chip 110 and the second video format conversion bridge chip 130 respectively, and the processor 120 is configured to receive the converted video signals outputted by the first video format conversion bridge chip 110, convert the converted video signals into first data format video signals, and transmit to the second video format conversion bridge chip 130. The second video format conversion bridge chip 130 is coupled to the processor 120 and a display screen 20 for receiving the first data format video signals and converting the first data format video signals into second data format video signals, and transmitting the second data format video signals to the display screen 20.

In operation, after the device for playing audio and video 10 receives the audio and video signals from a main signal source 30 or an external signal source 50 through the first video format conversion bridge chip 110, the data format of the audio and video signals is converted firstly, for example, when the first video format conversion bridge chip 110 is a bridge chip for converting HDMI into MIPI CSI, the first video format conversion bridge chip 110 converts the data format of the video signals in the audio and video signals from HDMI into MIPI CSI, and then transmits the signals to the processor 120. The processor 120, after receiving the converted audio and video signals, then converts the data format of the video signals in the audio and video signals, to facilitate complying with the receiving format of the second video format conversion bridge chip 130. For example, when the second video format conversion bridge chip 130 is a bridge chip for converting HDMI into V-by-One, the processor 120 converts the video signals into first data format video signals in HDMI, and then transmits the signals to the second video format conversion bridge chip 130.

The video format conversion bridge chip 130, after receiving the first data format video signals, converts the data format of the first data format video signals from HDMI data format into second data format video signals in V-by-One data format, then transmits the second data format video signals to the display screen 20 to play through a second video format output port 133 which has V-by-One data format as well, thus presenting high-definition picture on the display screen 20.

Therefore, in the device for playing audio and video of the present application, the sources and types of the audio and video signals that can be received by the processor is enlarged through the configuration of the first video format conversion bridge chip 110; meanwhile, the device for playing audio and video is enabled to possess the ability of processing large-scale software, for example, large-scale games or other high power consumption software, due to a manner of configuring the processor having performance indexes apparently higher than that of a general processor; moreover, the video signals received by the processor can be played on the display screen through converting the data format of the video signals by the second video format conversion bridge chip, thus improving the smoothness and quality of the display picture, and increasing the user experience at the same time.

Referring to FIG. 2, a device for playing audio and video 10 disclosed by a second embodiment of the present application is coupled with a main signal source 30, an audio system 40 and a display screen 20, wherein the main signal source 30 may be, but is not limited to a TV signal source, a signal source from internet or a signal source downloaded locally, while the audio system 40 and the display screen 20 may be, but are not limited to multimedia devices self-provided by the device for playing audio and video 10, or multimedia devices externally connected to the device for playing audio and video 10 in a detachable form. In addition, when such audio and video output equipment as a DVD player or a set top box or the like is plugged in the device for playing audio and video 10 to mutually couple with each other, the device for playing audio and video 10 may enable the audio and video output equipment to be served as an external signal source 50 so as to receive the audio and video signals from the audio and video output equipment to conduct audios and/or videos playing.

The device for playing audio and video 10 includes a first video format conversion bridge chip 110, a processor 120, a second video format conversion bridge chip 130 and a motion compensation frame rate converter 140, wherein the first video format conversion bridge chip 110 is coupled to the processor 120 through an inter-integrated circuit (Inter-Integrated Circuit, I2C) bus and an I2S (Inter-IC Sound) audio bus (also called as integrated circuit built-in audio bus), and the first video format conversion bridge chip 110 is electrically provided with a main audio-video signal input port 111 and an external audio-video signal input port 112. The main audio-video signal input port 111 and the external audio-video signal input port 112 may be, but are not limited to high definition multimedia interfaces (High Definition Multimedia Interface; hereinafter referred to as HDMI), and the main audio-video signal input port 111 is configured to be coupled to the main signal source, while the external audio and video input port 112 is configured to be coupled to the external signal source, so that the first video format conversion bridge chip 110 may receive the audio and video signals through the main audio-video signal input port 111 or the external audio-video signal input port 112, then convert the data formats of the audio signals and the video signals in the audio and video signals into a data format suitable to be received by the processor 120, for example, corresponding audio-video signal output port and input port which are preferably MIPI CSI ports 150 are set on the first video format conversion bridge chip 110 and the processor 120 respectively.

The processor 120 is a processor having a master frequency and a register bit higher than that of a general processor. For example, if the general processor has 32 bits and a master frequency of 1.2 GHz, then the processor 120 may be a 64-bit processor having a master frequency of 2˜2.5 GHz, wherein this is a relative value, and any processor having performance indexes apparently higher than that of a general processor (i.e., so-called high-performance processor) is applicable to be served as the processor 120 of the device for playing audio and video 10 in the embodiment of the present application.

The processor 120 is electrically provided with a first video format output port 121 and a processing module 122, wherein the processing module 122 includes a central processing unit (central processing unit, CPU) 111 and/or a graphic processing unit (graphic processing unit, GPU). While the first video format output port 121 may be, but is not limited to one of a mobile high-definition video-audio standard port (mobile high-definition link, MHL; hereinafter referred to as MHL port), an HDMI port, a low voltage differential signaling (Low Voltage Differential Signaling, LVDS) port, a DP port (display port), an EDP port (Embedded Display Port), an MIPI DSI interface (Mobile Industry Processor Interface-Display Serial Interface, mobile industry processor and display serial interface) and combinations thereof, and the processor 120 is namely coupled to the corresponding port on the second video format conversion bridge chip 130 through the first video format output port 121.

Furthermore, the processor 120 is also coupled to the second video format conversion bridge chip 130 and the motion compensation frame rate converter 140 respectively through an I2C bus; and is coupled to the audio system 40 through an I2S audio bus. Therefore, the processor 120 may receive the converted audio signals from the first video format conversion bridge chip 110, and transmit the signals to the audio system 40; and then convert the data format of the converted video signals into first data format video signals, for example, video signals in HDMI, to facilitate complying with the signal transmission format between the processor 120 and the second video format conversion bridge chip 130, and then transmit the first data format video signal to the second video format conversion bridge chip 130 through the first video format output port 121.

Wherein, the processor 120 is also coupled to an Ethernet module 160, a wireless communication module 170, a power management module 180 and a memory module 190 configured in the device for playing audio and video 10 respectively, and may obtain audio and video signals from the Ethernet module 160, the wireless communication module 170 or the memory module 190, and these audio and video signals may also be served as the audio and video signals of another main signal source, for example: audio and video signals received by such wireless or wired communication modes like the Ethernet module 160 or the wireless communication module 170; or audio and video data directly read from the memory module 190 or the like, and audio and video signals directly provided by the device for playing audio and video 10 itself. Moreover, the audio signals in these audio and video signals are transmitted to the audio system 40 and the video signals in these audio and video signals are transmitted to the second video format conversion bridge chip 130.

The second video format conversion bridge chip 130 is electrically provided with a first video format input port 131, a micro control unit (micro control unit, MCU) 132 and a second video format output port 133. The first video format input port 131, coupled to the first video format output port 121 of the processor 120, is configured to receive the first data format video signals from the processor 120. While the second video format output port 133, coupled to a second video format input port 141 that the motion compensation frame rate converter 140 is electrically provided with, is configured to transmit the video signals (i.e., the second data format video signals) to the motion compensation frame rate converter 140 after the data format of the first data format video signals is converted by the second video format conversion bridge chip 130.

Wherein, the data format of the first video format input port 131 of the second video format conversion bridge chip 130 is the same as the data format of the first video format output port 121 of the processor 120, for example, both of the two are HDMI data format; the data format of the second video format output port 133 of the second video format conversion bridge chip 130 is different from the data format of the first video format output port 121 of the processor 120, for example, the data format is V-by-One. It is to be understood that because the second video format output port 133 of the second video format conversion bridge chip 130 and the second video format input port 141 of the motion compensation frame rate converter 140 are a video signal output port and a video signal input port with corresponding data format, the data format of the second video format input port 141 of the motion compensation frame rate converter 140 in the embodiment is also V-by-Onedata format.

Besides being coupled to the second video format conversion bridge chip 130, the motion compensation frame rate converter 140, also coupled to the display screen 20, is configured to receive the second data format video signals from the second video format conversion bridge chip 130, and conduct frame rate conversion (frame rate conversion, FRC) on the second data format video signals based on motion estimation and motion compensation (motion estimation and motion compensation, MEMC) principle, so as to process the second data format video signals into high resolution and high frame rate video signals, for example, to improve the video contents with a common refresh rate of 60 Hz to video contents with a refresh rate of 120 Hz or 240 Hz, and then to transmit the high resolution and high frame rate video signals to the display screen 20 to play, thus improving the definition of motion picture.

The operation mode of the device for playing audio and video 10 disclosed by the second embodiment of the present application will be illustrated hereinafter through a specific implementation manner.

When the first video format conversion bridge chip 110 of the device for playing audio and video 10 receives the audio and video signals from the main signal source 30 or external signal source 50, a conversion of the data format is conducted direct at the audio and video signals firstly; for example, when the first video format conversion bridge chip 110 is a bridge chip for converting HDMI into MIPI CSI, the first video format conversion bridge chip 110 may receive the audio and video signals in HDMI data format through the main audio-video signal input port 111 or external audio-video signal input port 112 in HDMI data format, and then convert the data format of the audio signals in the audio and video signals from HDMI into I2S and convert the data format of the video signals from HDMI into MIPI CSI, and then transmit the signals to the processor 120.

After receiving the converted audio and video signals, the processor 120 transmits the audio signals in the audio and video signals to the audio system 40 to play through an I2S audio bus; and then converts the video signals in the audio and video signals, to facilitate complying with the receiving format of the second video format conversion bridge chip 130. For example, when the second video format conversion bridge chip 130 is a bridge chip for converting HDMI into V-by-One, the processor 120 converts the video signals into first data format video signals in HDMI data format, and then transmits the first data format video signals to the second video format conversion bridge chip 130 through the transmitting of the first video format input port 121 and the receiving of the first video format output port 131 in HDMI data format similarly.

The video format conversion bridge chip 130, after receiving the first data format video signals, converts the data format of the first data format video signals from HDMI data format into the second data format video signals in V-by-One data format, and then transmits the second data format video signals to the motion compensation frame rate converter 140 through the second video format output port 133 in V-by-One data format similarly.

Next, after receiving the second data format video signals through the second video format input port 141, the motion compensation frame rate converter 140 conducts motion estimation, motion compensation and frame rate conversion on the second data format video signals, so that the second data format video signals are processed into high resolution and high frame rate video signals. Then, the high resolution and high frame rate video signals are transmitted to the display screen 20 to play, thus presenting high definition picture on the display screen 20.

Therefore, in the device for playing audio and video of the present application, the sources and types of the audio and video signals that can be received by the processor are enlarged through the configuration of the first video format conversion bridge chip 110; meanwhile, the device for playing audio and video is enabled to possess the ability of processing large-scale software, for example, large-scale games or other high power consumption software, through a manner of configuring the processor having performance indexes apparently higher than that of a general processor; moreover, the video signals received by the processor can be played on the display screen through converting the data format of the video signals by the second video format conversion bridge chip; and high resolution and high frame rate video signals are provided to the display screen through optimizing the converted video signals by the motion compensation frame rate converter, thus improving the quality of the display picture, and increasing the user experience at the same time.

It should be illustrated that in the device for playing audio and video of the present application, if the distance between the processor and the second video format conversion bridge chip is close and long-distance signal wire routing is not needed, or the motion compensation frame rate converter is not used, the function of the motion compensation frame rate converter may be closed, or the configuration of the motion compensation frame rate converter may be omitted.

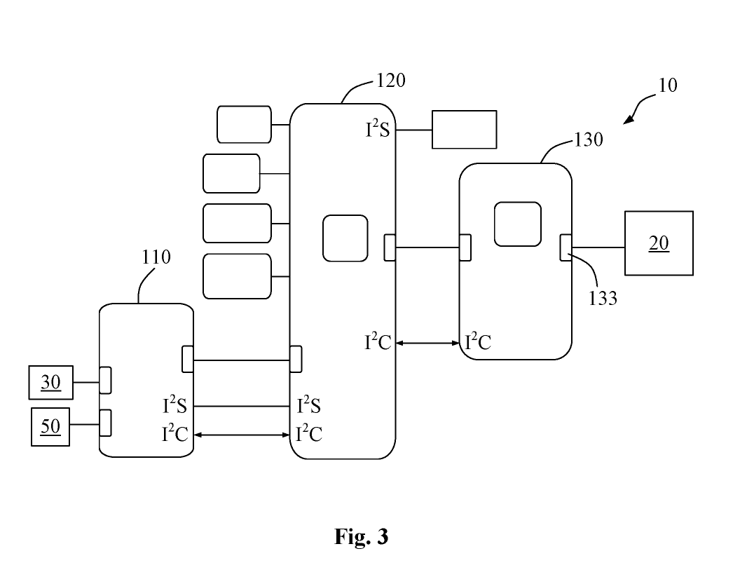

FIG. 3 is a block diagram of a third embodiment of the device for playing audio and video according to the present application. The third embodiment disclosed by the present application is approximately the same as the second embodiment in system architecture, while the differences between the two lie in that the device for playing audio and video 10 disclosed by the third embodiment of the present application includes a first video format conversion bridge chip 110, a processor 120 and a second video format conversion bridge chip 130, wherein the first video format conversion bridge chip 110 is coupled to a main signal source 30 and/or an external signal source 50, the processor 120 is coupled between the first video format conversion bridge chip 110 and the second video format conversion bridge chip 130, while the second video format conversion bridge chip 130 is coupled to a display screen 20 through a second video format output port 133. Therefore, when audio and video signals from a main signal source 30 and/or an external signal source 50 are inputted from the first video format conversion bridge chip 110, and when the video signals therein are converted into first data format video signals by the processor 120, the first data format video signals are converted into second data format video signals through the second video format conversion bridge chip 130, and are directly transmitted to the display screen 20 to play, thus omitting high resolution and high frame rate processing program.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer equipment (which may be a personal computer, a server, or a network equipment or the like) to execute the method according to each embodiment or some parts of the embodiments.

It should be finally noted that the above embodiments are only configured to explain the technical solutions of the present application, but are not intended to limit the present application. Although the present application has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of various embodiments of the present application.

What is claimed is:

1. A device for playing audio and video, comprising: a first video format conversion bridge chip, a processor and a second video format conversion bridge chip, wherein,
the first video format conversion bridge chip is configured to receive audio and video signals, and convert the data format of the video signals in the audio and video signals;
the processor which is coupled to the first video format conversion bridge chip and the second video format conversion bridge chip respectively, receives the converted video signals outputted by the first video format conversion bridge chip, converts the converted video signals into first data format video signals, and transmits the first data format video signals to the second video format conversion bridge chip; and
the second video format conversion bridge chip, coupled to the processor and a display screen, is configured to receive the first data format video signals and convert the first data format video signals into second data format video signals, and transmit the second data format video signals to the display screen.

2. The device for playing audio and video according to claim 1, wherein,
the first video format conversion bridge chip is electrically provided with a main audio-video signal input port and an external audio-video signal input port, the main audio-video signal input port is coupled to a main signal source, and the external audio-video input port is coupled to an external signal source.

3. The device for playing audio and video according to claim 1, further comprising:
a motion compensation frame rate converter, coupled between the second video format conversion bridge chip and the display screen, and configured to receive and process the converted video signals into high resolution and high frame rate video signals, and transmit the high resolution and high frame rate video signals to the display screen.

4. The device for playing audio and video according to claim 2, further comprising:
a motion compensation frame rate converter, coupled between the second video format conversion bridge chip and the display screen, and configured to receive and process the converted video signals into high resolution and high frame rate video signals, and transmit the high resolution and high frame rate video signals to the display screen.

5. The device for playing audio and video according to claim 3, wherein,
the processor is electrically provided with a first video format output port, which is coupled to the second video format conversion bridge chip;
the second video format conversion bridge chip is electrically provided with a first video format input port and a second video format output port, the first video format input port is coupled to the first video format output port, and the second video format output port is coupled to the motion compensation frame rate converter; and
the motion compensation frame rate converter is electrically provided with a second video format input port, which is coupled to the second video format output port.

6. The device for playing audio and video according to claim 5, wherein the first video format conversion bridge chip is a bridge chip for converting HDMI into MIPI CSI, and the data formats of the main audio-video signal input port and the external audio-video signal input port are HDMI respectively.

7. The device for playing audio and video according to claim 5, wherein the second video format conversion bridge chip is a bridge chip for converting HDMI into V-by-One, and the data format of the first video format input port is HDMI, and the data format of the second video format output port is V-by-One.

7. The device for playing audio and video according to claim 3, wherein the processor is coupled to the first video format conversion bridge chip, the second video format conversion bridge chip and the motion compensation frame rate converter respectively through an I²C bus.

8. The device for playing audio and video according to claim 1, wherein the processor is coupled to an audio system, and the processor is coupled to the audio system and the first video format conversion bridge chip through an I²S audio bus; when the first video format conversion bridge chip converts the data format of the audio signals in the audio and video signals, the processor transmits the converted audio signals to the audio system.

9. The device for playing audio and video according to claim 2, wherein the device for playing audio and video is a TV set, the main signal source is a TV signal source, a signal source from internet or a signal source downloaded locally, and the external signal source is an audio and video signal source of a video and audio device externally connected to the device for playing audio and video.

10. The device for playing audio and video according to claim 1, wherein the processor is further coupled with one of Bluetooth, WIFI, Ethernet, a 2.4G communication module, a memory module and combinations thereof.

11. The device for playing audio and video according to claim 2, further comprising:
a motion compensation frame rate converter, coupled between the second video format conversion bridge chip and the display screen, and configured to receive and process the converted video signals into high resolution and high frame rate video signals, and transmit the high resolution and high frame rate video signals to the display screen.

12. The device for playing audio and video according to claim 5, wherein the second video format conversion bridge chip is a bridge chip for converting HDMI into V-by-One, and the data format of the first video format input port is HDMI, and the data format of the second video format output port is V-by-One.
